(19) United States
(12) Patent Application Publication
(10) Pub. No.: US 2003/0181070 A1
(43) Pub. Date: Sep. 25, 2003

(54) Electric connector

(76) Inventors: Rainer Topp, Reutlingen (DE); Achim Henkel, Reutlingen (DE); Reinhard Milich, Reutlingen (DE)

Correspondence Address: KENYON & KENYON, ONE BROADWAY, NEW YORK, NY, 10004, US

(21) Appl. No.: 10/297,899

(22) PCT Filed: Mar. 28, 2002
(86) PCT No.: PCT/DE02/01135

(30) Foreign Application Priority Data
Apr. 10, 2001 (DE) 101 17 798.4

(51) Int. Cl. H01R 13/04

(52) U.S. Cl. 439/44; 439/692

(57) ABSTRACT

A plug connector is proposed, in particular for a control device (100), which includes a plug input having at least two input connections (1, 2, 3), a plug output having at least two output connections (4, 5, 6), and at least one connecting part (10, 20) via which the respective associated connections (1, 2, 3, 4, 5, 6)—input connection and output connection—are interconnected.

To be able to exclusively use simple connecting parts which, moreover, may also be used to implement a plurality of plug variants, the plug input and the plug output are decoupled by providing at least one first connecting part (10) which solely includes input connections (1, 2, 3), and at least one additional connecting part (20), which solely includes output connections (4, 5, 6). The two connecting parts (10, 20) are placed one over the other in such a way that the respective associated connections are superposed at at least one intersecting point. The respective associated connections are interconnected by contacting areas (7) at the intersecting point.

### BACKGROUND INFORMATION

The present invention is directed to a plug connector, especially for a control device, including a plug input having at least two input terminals, a plug output having at least two output terminals, and at least one connecting part via which the respective associated terminals—input terminal and output terminal—are interconnected.

In many plug-connector applications, for instance in the motor vehicle field, the market requires a great variety of plug connectors, i.e. plugs that, given a certain assignment of the plug inputs, differ in the assignment of the plug outputs. An example to be mentioned in this context is the regulator of an electric generator whose plug, depending on the vehicle type, can have different output assignments. In practice, the multitude of plug connector variants is implemented with the aid of appropriately configured inserts, which are used as connecting parts. The geometry of these connecting parts is complex, in particular when three-dimensional cross-connections are needed in order to provide the desired assignment at the connector output terminal. Since practically every plug connector variant is provided with an individually configured connecting part, the plug housings, which are adapted to the geometry of the respective connecting part, generally differ as well. Overall, this results in relatively high manufacturing costs.

### SUMMARY OF THE INVENTION

The present invention proposes a plug connector for which substantially simpler connecting parts are exclusively used. However, these connecting parts may also be used to implement a plurality of plug connector variants. This has an overall advantageous effect on the manufacturing costs.

This is achieved according to the present invention by the fact that the plug input and the plug output are decoupled in that at least one first connecting part including only input terminals is provided, and at least one second connecting part, which only includes output terminals is provided. The two connecting parts are arranged on top of one another in such a way that the respective associated terminals are superposed at at least one intersecting point, and that the respective associated terminals are interconnected by contacting areas at the intersecting point.

The present invention recognizes that the decoupling of the plug input and the plug output allows a considerable simplification of the terminal design, i.e. the geometries of the input terminals and the output terminals. By using two superposed connecting parts—a first connecting part only for the input terminals and a second connecting part only for the output terminals—the need for costly three-dimensional cross-connections is eliminated. According to the present invention, these non-contacting line crossings are located at the interface between plug input and plug output, namely between the two connecting parts. This considerably reduces the complexity of the connecting parts themselves, thereby positively affecting the manufacturing costs. The present invention recognizes, moreover, that such connecting parts, given an appropriate geometry of the terminals, may be used, without adaptation or modification, for implementing different connector plug variants, which likewise has a positive effect on the manufacturing costs.

Different geometric designs of the connecting parts or the input terminals and the output terminals are fundamentally possible.

In one advantageous variant of the connector plug according to the present invention, the first connecting part is provided with a separate terminal connector strip for each input terminal, this strip including at least as many connecting points as there are possible associated output terminals. In this case, each output connection is connected to the associated input connection via a connecting point on the corresponding terminal connector strip. The coding of the connector plug is particularly uncomplicated here, since the output connections may be optionally simply assigned to one of the input connections and be connected thereto. For this purpose, each output connection on the second connecting part must be conducted merely to the appropriate connection point on the terminal connector strip of the associated input connection.

Alternatively to the afore-described variant of a plug connector according to the present invention, the second connecting part may likewise be provided with a separate terminal connector strip for each of the output connections, this terminal connector strip including at least as many connecting points as there are possible associated input connections. In this case, each input connection is connected to the associated output connection via a connecting point on the corresponding terminal connector strip. For the coding of the connector plug, it will then be necessary to conduct each input connection on the first connecting part the corresponding connecting point on the terminal connector strip of the associated output connection.

It is particularly advantageous if both the first as well as the second connecting part are provided with a separate terminal connector strip for each of their connections, the strip including at least as many connecting points as there are possible associated connections. In this case, the connector plug may be coded in an especially simple manner if the connecting points of the two connecting parts are arrayed in connecting-point grids that are adapted to one another, i.e., in grids having identical contact spacing. In this context, it is particularly advantageous if the two connecting parts are arranged on top of one another in such a way that their contact-spacing grid is superposed, but rotated with respect to one another in a way that allows any possible connection of an input connection to an output connection simply by connecting two superposed connecting points.

Due to their simple geometries, the connecting parts of the plug connector according to the present invention may be advantageously produced as sheet-metal stamped parts, especially in the form of pressed screens. In this case, the two connecting parts must be electrically insulated from one another by introducing a suitable insulator material. However, the connecting parts may also be implemented in the form of an electrically insulating carrier, onto which circuit traces are applied. Suitable for the contacting of two connections or connecting points are joints produced by soldering, welding, bonding, thermo-compression or also clamping.

### BRIEF DESCRIPTION OF THE DRAWINGS

There are various ways to advantageously embody and further refine the teaching of the present invention. For this purpose, in addition to the aforementioned explanations, reference is made, on the one hand, to the subordinate claims to claim 1 and, on the other hand, to the following description of two exemplary embodiments of the present invention in light of the drawing, whose figures show:

FIG. 1 a plan view of the first connecting part of a plug terminal according to the present invention, the first connecting part having three input terminals in this case;

FIG. 2 a first connection variant of the input connections shown in FIG. 1, including the associated output connections of the plug terminal according to the present invention;

FIG. 3 a second connection variant of the input connections shown in FIG. 1, including the associated output connections of the plug connector according to the present invention; and

FIG. 4 a section through a plug terminal according to the present invention.

### DESCRIPTION OF THE EXEMPLARY EMBODIMENTS

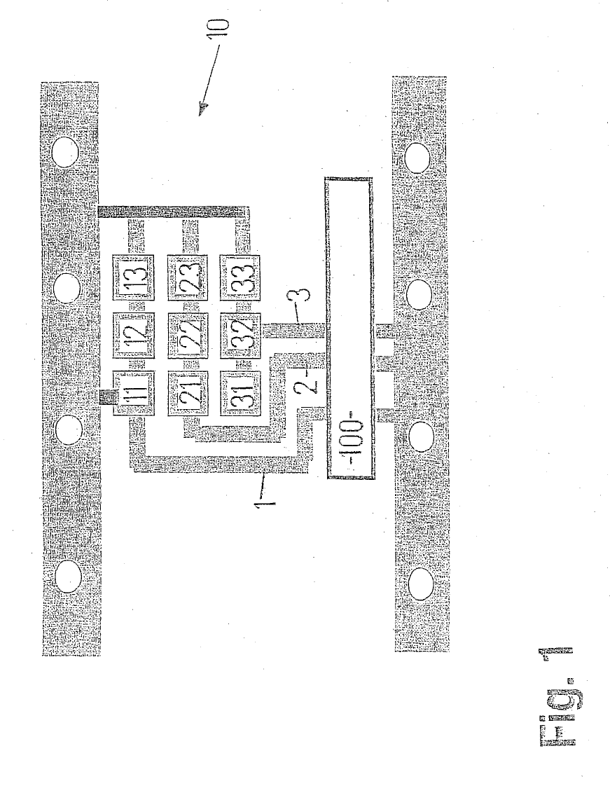

FIG. 1 shows a first connecting part 10 of a plug terminal according to the present invention for a control device 100. Connecting part 10 is implemented as an insert in the form of a sheet-metal stamped part. In the exemplary embodiment shown here, connecting part 10 only includes all the input connections of the plug terminal, namely the three input connections 1, 2 and 3, which are connected to outputs of control device 100.

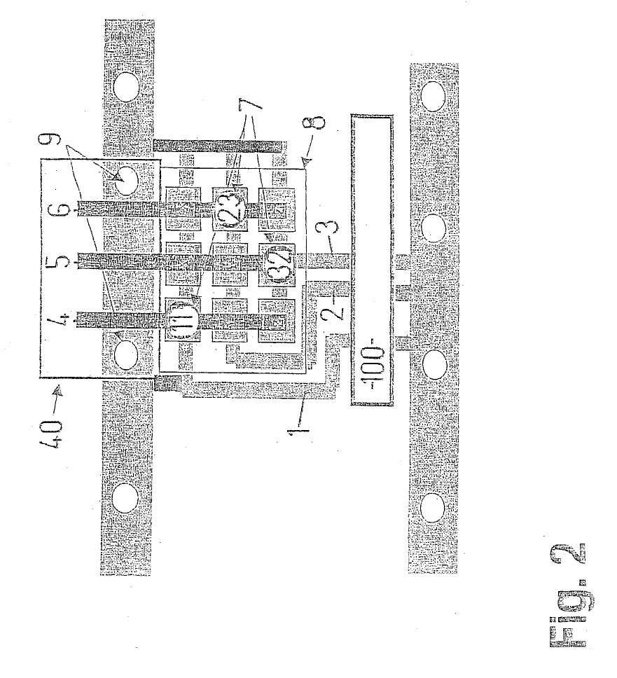

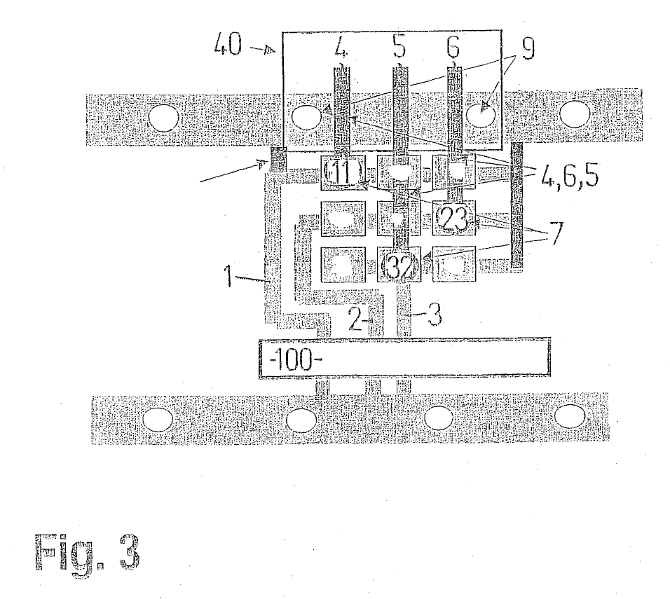

According to the present invention, the plug output, which is not shown here and is discussed in greater detail only in connection with FIGS. 2 and 3, is decoupled from the plug input in that a second connecting part is provided, which exclusively encompasses all the output connections. The two connecting parts are arranged in the plug housing on top of one another in such a way that the respective associated connections—input connection and output connection—are superposed at at least one intersecting point. The respective associated connections are interconnected at the intersecting point. In all other respects, the two connecting parts are insulated from one another.

All input connections 1, 2 and 3 are implemented in the form of a terminal strip. Since the plug connector in the exemplary embodiment shown here includes three output connections, each of the three terminal connector strips 1, 2 and 3, which are disposed in parallel to one another, is designed to include three connecting parts 11, 12, 13; 21, 22, 23 and 31, 32, 33, so that these connecting points 11, 12, 13; 21, 22, 23 and 31, 32, 33 are arrayed in a grid.

The number of connecting points 11, 12, 13; 21, 22, 23 and 31, 32, 33 and their arrangement make possible a simple connection of the output connections to the associated input connections, independently of which terminals are combined with each other.

In the connection variant shown in FIG. 2, the three output connections 4, 5 and 6 of plug output 40 are likewise disposed in parallel to one another, but perpendicularly to terminal connector strips 1, 2 and 3 of first connecting part 10. Moreover, output terminals 4, 5 and 6 are dimensioned such that they each cover a connecting point of each input connection 1, 2, 3. In this variant, all possible plug-terminal codings, i.e., combinations of input and output connections, may be implemented in an uncomplicated manner by each output connection 4, 5 and 6 of the second connecting part making contact with the corresponding connecting point of the first connecting part. Even a permutating coding does not require specialized connecting parts with three-dimensional connection crossings.

Since contacting areas 7 shown in FIG. 2 between the first and the second connecting part specify the assignment of the individual input connections to the individual output connections and, thus, determine the coding of the plug connector, they are here referred to as coding connecting points 7. An insulation 8 is located between the first and the second connecting part. The areas of first connecting part 10 designated by the reference numeral 9, are used to pre-fix terminal output 40. These pre-fixation areas 9 need not necessarily be part of the finished plug connector. From a standpoint of production engineering, they are merely required before the two connection parts are joined.

In the connection variant shown in FIG. 3, the three output connections 4, 5 and 6 of plug output 40, are each brought merely to the corresponding connection point of the associated input connection 1, 2 or 3. In this variant, the coding of the plug connector does not occur solely via contacting areas 7, but already takes place when output connections 4, 5 and 6 are formed.

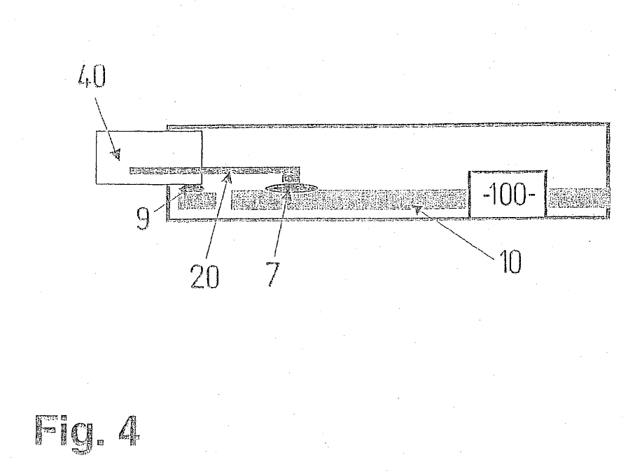

FIG. 4, on the basis of the variant shown in FIG. 3, once again illustrates the decoupling of the plug input from plug output 40 according to the present invention, through the use of a first connecting part 10, which solely encompasses input connections and is implemented here in the form of a standard punched metal part, and a second connecting part 20, which solely includes output connections and is realized here in the form of an insert. First connecting part 10 forms the input level of the plug connection according to the present invention, whereas the second connecting part forms the output level. The non-contacting crossing of connections is shifted to the interface between input level and output level and takes place here via the three input connections implemented as terminal connector strips, which the output connections optionally access. Depending on the coding, any combination of input connections with output terminals is possible. The coupling of the input level with the output level is achieved by contact regions in the area of the terminal connector strips. In this manner, it is possible to reduce the complexity of the connecting parts to such an extent that they may also be implemented in the form of simple pressed screens, which are largely independent of the plug coding. To implement different plug codings, it is merely necessary to position the coded connections in a different way.

The coded terminals may be implemented, for instance, by joints produced by soldering, welding, adhesive bonding, thermo-compression or clamping. The two connecting parts 10 and 20 are accommodated in a housing 50 in this case, in which control device 100 is located as well.

What is claimed is:

1. A plug connector, in particular for a control device (100) comprising
a plug input having at least two input connections (1, 2, 3);
a plug output having at least two output connections (4, 5, 6);
and
at least one connecting part (10, 20) via which the respective associated connections (1, 2, 3, 4, 5, 6), i.e. input connection and output connection, are interconnected, wherein the plug input and the plug output are decoupled in that at least a first connecting part (10) is provided, which solely includes input connections (1, 2, 3), and at least one second connecting part (20), which solely includes output connections (4, 5, 6); the two connecting parts (10, 20) are arranged on top of one another, so that the respective associated connections are superposed at at least one intersecting point; and the respective associated connections are connected to each other at the intersection point by a contact region (7).

2. The plug connector as recited in claim 1, wherein the first connecting part (10) includes a separate terminal connector strip for each input connection (1, 2, 3), which provides at least as many connecting points (11, 12, 13; 21, 22, 23; 31, 32, 33) as there are possible associated output connections (4, 5, 6), so that each output connection (4, 5, 6) is connected to the associated input connection (1, 3, 2) via a connecting point (11, 32, 23) on the respective terminal connector strip (1, 3, 2).

3. The plug terminal as recited in claim 2, wherein each output connection (4, 5, 6) on the second connecting part (20) is conducted only to the terminal connector strip (1, 3, 2) of the associated input connection (1, 3, 2).

4. The plug connector as recited in one of claims 1 or 2, wherein the second connecting part includes a separate terminal connector strip for each output connection, which includes at least as many connecting points as there are possible associated input connections, so that each input connection is connected to the associated output connection via a connection point on the appropriate terminal connector strip.

5. The plug connector as recited in claim 4, wherein each input connection on the first connecting part is conducted only up to the terminal connector strip of the associated output connection.

6. The plug connector as recited in one of claims 2 through 5, wherein the connecting points of each connecting part are arrayed in a terminal grid.

7. The plug connector as recited in claims 2, 4 and 6, wherein the two connecting parts are arranged on top of one another in such a way that their terminal grid is superposed, but rotated with respect to each other in such a way that any possible connection of an input connection to an output connection may be implemented by simply connecting two superposed connecting points.

8. The plug connector as recited in one of claims 1 through 7, wherein at least one connecting part (20) is implemented as a sheet-metal stamped part, especially in the form of a pressed screen.

9. The plug connector as recited in one of claims 1 through 8, wherein at least one connecting part is implemented in the form of a circuit board and/or is provided with circuit conductors.

10. The plug connector as recited in one of claims 1 through 9, wherein the contact regions (7) of two connections or connection points are implemented as joints produced by soldering, welding, bonding, thermo-compression or clamping.
